(19) United States
(12) Patent Application Publication
(10) Pub. No.: US 2002/0124038 A1
(43) Pub. Date: Sep. 5, 2002

(54) Processor for processing variable length data

(76) Inventors: Masahiro Saitoh, Kawasaki (JP); Syuji Takada, Kawasaki (JP); Yasuhiro Ooba, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/817,074

(22) Filed: Mar. 26, 2001

(30) Foreign Application Priority Data
Aug. 18, 2000 (JP) 2000-248696

(51) Int. Cl. G06F 7/38; H04J 3/22; H04J 3/16

(52) U.S. Cl. 708/513; 370/470

(57) ABSTRACT

A processor, including a plurality of arithmetic and logic units for processing data for every bit in a word (W) unit, for processing variable length data, preferred for a communication oriented application, excellent in real time operability and a high speed processability, and capable of flexibly coping with changes in function, addition of functions, etc., provided with a processing mask control unit for dividing the data to be processed and data not to be processed, a carry mask control unit for controlling propagation of carry among the arithmetic and logic units, and a bit switch control unit for switching bits between two sets of data to be processed.

### BACKGROUND OF THE INVENTION

1. Field of the Invention

The present invention relates to a processor for processing variable length data suitable for processing of data used in Internet protocol (IP), asynchronous transfer mode (ATM), synchronous data hierarchy (SDH), and other data communication, that is, data having a frame structure.

2. Description of the Related Art

In a communication oriented application, high real time operability is demanded in many cases. So-called variable length data wherein the width of the data covered or the location of accommodation of the data in the frame vary in accordance with the content of the data processing is frequently handled.

In ATM, SDH, and other data communication, processing has been carried out by extracting only specific bits from the headers of the packets to be transmitted. Also, in the recently rapidly growing IP communication, demand has been rising for communication oriented applications requiring processing of variable length data, for example, processing of the variable length header in the packets to be transmitted.

Conventionally, in the design of the LSI required for the development of the above communication oriented applications, the practice has been to assemble dedicated hardware to realize the LSI.

When using such an LSI comprised of dedicated hardware, however, the flexibility with respect to changes in functions, addition of functions, changes in specifications, etc. of the applications becomes extremely low. In spite of a fact that such an altered or augmented LSI is an LSI having functions considerably close to the original LSI, it was necessary to newly redevelop the related LSI. Due to the redevelopment, the cost increased or it became impossible to achieve quick response (time-to-market).

In view of this situation, in recent years, LSIs capable of being programmed by building processors therein have appeared. By building in a processor and preparing a program for every processing function, it becomes possible to process a plurality of protocols by a single LSI. Further, by just changing the program, it becomes possible to flexibly deal with the above changes in functions, addition of functions, changes in specifications, etc.

However, realization of communication oriented applications by an LSI including a single processor therein is almost impossible in actual circumstances in view of the processing speed required for the communication. It is very difficult to achieve the required processing speed by a processor built in an LSI—particularly in a case of switching of bits in encoding/decoding of data such as in interleaving/deinterleaving necessary for communication and in a case of processing data, which data is variable in bit location and variable in its width.

The reason for this is that the processor in an LSI is not designed for processing of variable length data and handles only fixed length data. Due to this, when trying to process variable length data using an existing processor, processing (preprocessing) of the data such as the loading of data to be processed, shifting for positioning of data, and masking of bits unnecessary for processing becomes necessary. In the final analysis, this processing of data becomes a bottleneck in realizing a practical LSI.

Summarizing the problems to be solved by the invention, there are three problems in current processors for processing variable length data:

1) The need for preprocessing of the data by combination of shift instructions and mask instructions of data in order to process data in any field in a word.

2) Due to the first problem, the need for instructions for the above preprocessing and therefore the increase in the capacity of an instruction memory required for one processing.

3) The need for addition of dedicated hardware for the above processing (preprocessing) of data when further higher speed processing is required according to the content of processing above and beyond the high speed processing originally required for communication.

### SUMMARY OF THE INVENTION

An object of the present invention is to provide a processor for processing variable length data capable of simultaneously solving the above problems.

To attain the above object, according to the present invention, there is provided a processor including a plurality of arithmetic and logic units (5) for processing data for every bit in a word (W) unit, comprised of a processing mask control unit (4) for dividing the data to be processed and data not to be processed, a carry mask control unit (12) for controlling propagation of carry among the arithmetic and logic units (5), and a bit switch control unit (34) for freely switching bits between two sets of data to be processed. Due to this configuration, it becomes possible to realize a processor for processing variable length data excellent in real time operability and high speed processability and capable of flexibly coping with changes in functions, addition of functions, etc.

### BRIEF DESCRIPTION OF THE DRAWINGS

The above object and features of the present invention will be more apparent from the following description of the preferred embodiments given with reference to the accompanying drawings, wherein:

FIG. 1 is a view of a first principal portion of a processor according to the present invention;

FIG. 2 is a view of a second principal portion of the processor according to the present invention;

FIG. 3 is a view of a first modification of the second principal portion shown in FIG. 2;

FIG. 4 is a view of a second modification of the second principal portion shown in FIG. 2;

FIG. 5 is a view of a third principal portion of the processor according to the present invention;

FIG. 6 is a view of a fourth principal portion of the processor according to the present invention;

FIG. 7 is a view of a first example of the overall configuration of a processor according to the present invention;

FIG. 8 is a view further concretely showing the configuration of FIG. 7;

FIG. 9 is a view of a second example of the overall configuration of a processor according to the present invention;

FIG. 10 is a first part of a view of a data structure used for an explanation of a bit switch control unit 34;

FIG. 11 is a second part of a view of the data structure used for the explanation of the bit switch control unit 34;

FIG. 12 is a view of the flow of processing in a case of processing a data structure shown in FIG. 11;

FIG. 13 is a view of an arithmetic and logic unit array partially employed in the flow of processing represented in FIG. 12;

FIG. 14 is a view further concretely showing the configuration of FIG. 9;

FIG. 15 is a view of a third example of the overall configuration of a processor according to the present invention;

FIG. 16 is a view of a processor 1 having a multiprocessor configuration according to the present invention;

FIG. 17 is a view of an example of the overall configuration of FIG. 16;

FIG. 18 is a view of a detailed example of the overall configurations shown in FIG. 16 and FIG. 17;

FIG. 19 is a view of the typical configuration of instructions for operating the processor according to the present invention; and

FIG. 20 is a view of the configuration of an instruction based on the present invention for operating the processor according to the present invention.

### DESCRIPTION OF THE PREFERRED EMBODIMENTS

Preferred embodiments of the present invention will be described in detail below while referring to the attached figures.

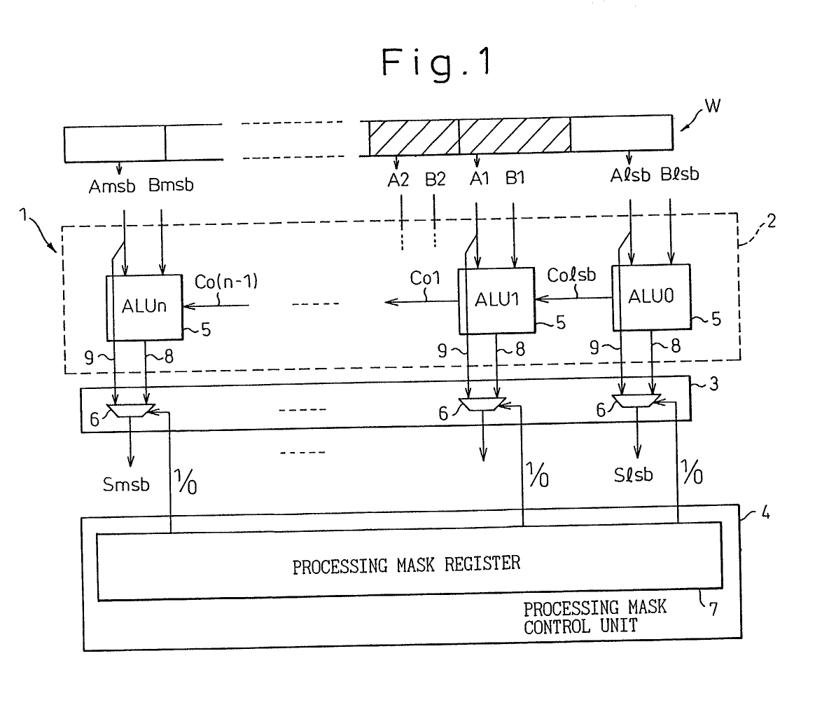

FIG. 1 is a view of a first principal portion of a processor according to the present invention.

In the figure, reference numeral 1 denotes a processor for processing variable length data according to the present invention (hereinafter, simply also referred to as a processor) and roughly comprised of an arithmetic and logic unit array 2, an output select unit 3, and a processing mask control unit 4.

First, the processor 1 of the present invention is a processor including a plurality of arithmetic and logic units (ALUs) 5 for processing the data for every bit in a word unit.

The processing mask control unit 4 designates bits for dividing the data in each word W to data to be processed and other data not to be processed.

Also, the output select unit 3 selectively validates the function of processing by the arithmetic and logic unit 5 in correspondence with the related bits for the above data to be processed and fetching results of the processing according to the above designation of bits by the processing mask control unit 4 and the function of passing the data not to be processed through the arithmetic and logic unit 5 in correspondence with the related bits.

Note that, in FIG. 1, the meanings of the symbols are as follows:

Alsb: Least significant bit of input A

Blsb: Least significant bit of input B

Amsb: Most significant bit of input A

Bmsb: Most significant bit of input B

ALU0: Arithmetic and logic unit (5) (ALU) of least significant bit

ALUn: Arithmetic and logic unit (5) of most significant bit

Co lsb: Carry output of least significant bit (carry out)

Slsb: Result of processing for least significant bit

Smsb: Result of processing for most significant bit

Here, the input A is an externally given data to be communicated (word W), while the input B is the data stored in for example a table in the processor 1. Also, the data to be processed (bit data) of the input A is indicated by hatching in the figure as an example.

More concretely, the processing mask control unit 4 has a processing mask register 7 for storing a logic 1 or 0 designating whether each bit (Alsb, A1, A2, . . . ) in each word W is a bit to be processed or a bit not to be processed corresponding to each bit.

Note that the storage of the logic 1 or 0 to the processing mask register 7 is set externally preceding the execution of the processing by the arithmetic and logic unit 5.

Also, the output select unit 3 is comprised of output selectors 6 receiving as input both of the result of processing from the arithmetic and logic unit 5 and the data not to be processed passed through this arithmetic and logic unit 5, in correspondence with each bit, selecting one of the above result and the above data and outputting the selected one. Each output selector 6 performs the selection according to the logic 1 or 0 (1/0 in the figure) from the processing mask register 7.

Note that the result of processing is transferred over a line 8 in the figure. At the above pass through, the data is transferred via a line 9 in the figure.

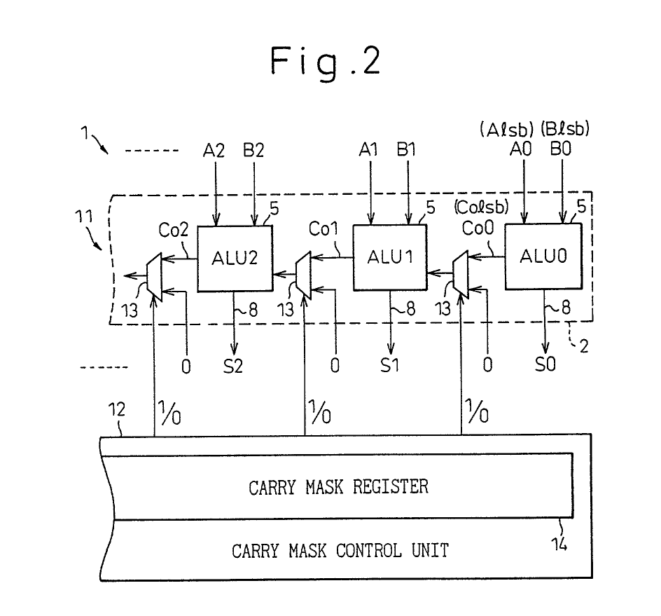

FIG. 2 is a view of a second principal portion of the processor according to the present invention. Note that, throughout all drawings, similar configuration elements are indicated by identical reference numerals or symbols.

In the figure, the processor 1 has the arithmetic and logic unit array 2 including a plurality of arithmetic and logic units (ALU) 5 the same as FIG. 1. Also, the line 8 is similar to that of FIG. 1, but the line 9 is provided according to need.

The second principal portion shown in the figure is roughly comprised of a carry select unit 11 and a carry mask control unit 12.

The carry mask control unit 12 designates a carry propagation for setting whether or not the carry (Co0, Co1, . . . ) produced from one arithmetic and logic unit is to be propagated to the other arithmetic and logic unit, between adjoining arithmetic and logic units (5), in correspondence with each bit.

Also, the carry select unit 11 selectively validates the function of propagating the carry from one arithmetic and logic unit 5 to the other arithmetic and logic unit 5 according to the carry propagation designation by the carry mask control unit 12 and the function of giving a fixed logic (indicated by 0 in the figure) determined in advance as the carry to the other arithmetic and logic unit 5.

More concretely, the carry mask control unit 12 has a carry mask register 14 for storing the logic 1 or 0 for designating whether to propagate the carry or give a fixed logic (0 in the figure) in correspondence with each bit.

Note that the storage of the logic 1 or 0 to the carry mask register 14 is externally set preceding the execution of the processing by the arithmetic and logic unit 5.

Also, the carry select unit 11 is concretely comprised of carry selectors 13 receiving as input both of the carry from the arithmetic and logic unit 5 and the fixed logic (0), in correspondence with each bit, selecting one of the above carry and the above fixed logic and outputting the selected one. Each carry selector 13 performs the selection according to the logic 1 or 0 (1/0 in the figure) from the carry mask register 12.

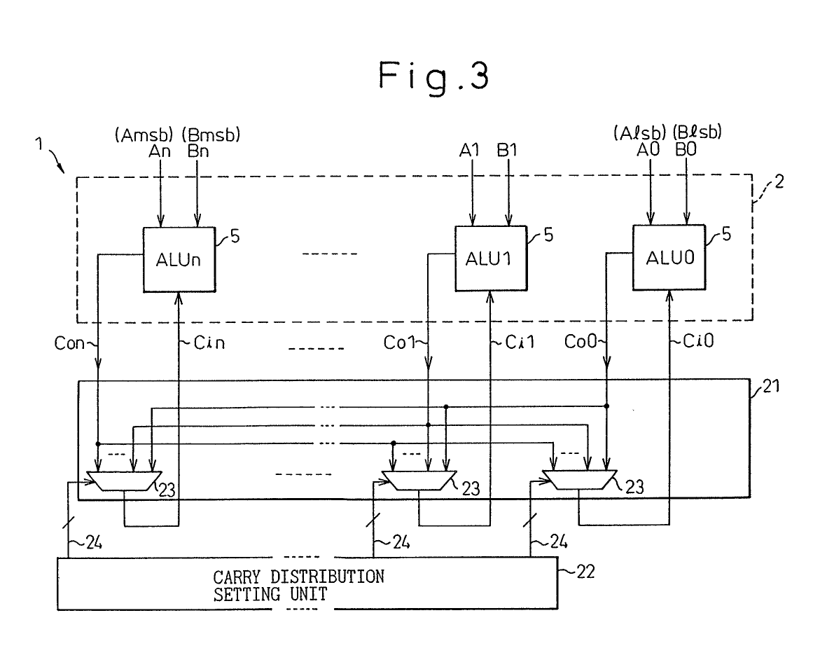

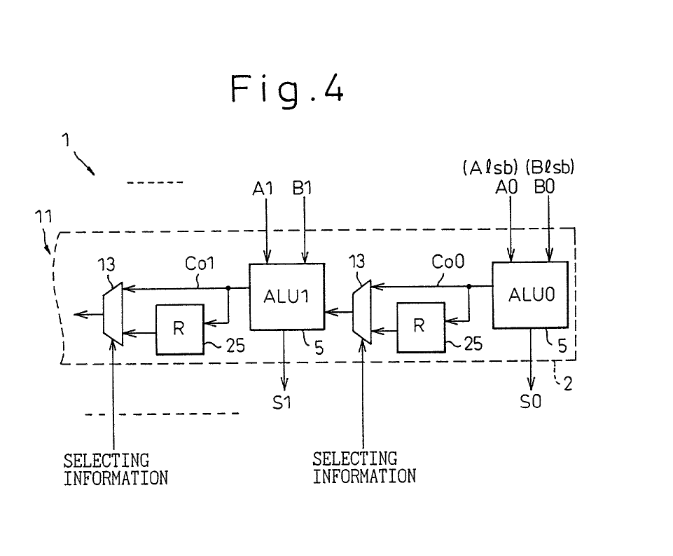

FIG. 3 is a view of a first modification of the second principal portion shown in FIG. 2, while FIG. 4 is a view of a second modification of the second principal portion shown in FIG. 2.

Referring to FIG. 3 first, a carry distribution unit 21 is shown in place of the carry select unit 11 of FIG. 2. This carry distribution unit 21 is for propagating the carry produced from one arithmetic and logic unit between arithmetic and logic units (5) to the other arithmetic and logic unit.

More concretely, the carry distribution unit 21 is comprised of carry selectors 23 receiving as input the carries (Co0, Co1, . . . ) produced from the arithmetic and logic units 5 in correspondence with each bit, selecting one carry (Ci0, Ci1, . . . ) determined in advance, and propagating the same to the arithmetic and logic units 5 in correspondence with each bit. Preferably it further has a carry distribution setting unit 22.

This carry distribution setting unit 22 determines in advance from which arithmetic and logic unit 5 the carry (Co0, Co1, . . . ) produced is to be selected for each carry selector 23 and designates the same.

This carry distribution setting unit 22 corresponds to the carry mask register 14 shown in FIG. 2, but while this register 14 receives one bit of selecting information 1/0, in the first modification of FIG. 3, it must select one from among the carries (Co0, Co1, . . . Con) corresponding to multiple bits (2 bits or more). Therefore a line 24 for transferring this selecting information becomes a multibit line.

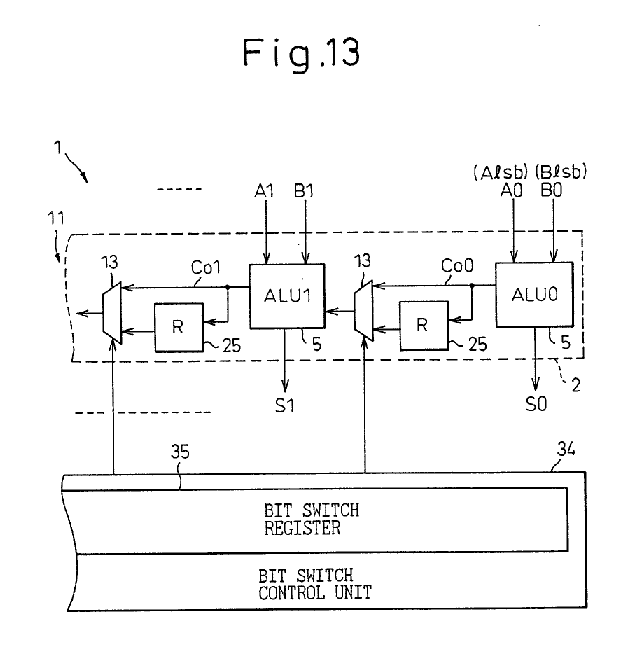

When viewing the second modification by referring to FIG. 4 next, the carry select unit 11 (corresponding to 11 of FIG. 2) can perform the selection by adding the function of selecting the carry from a memory device (for example register) 25 for storing carries produced by a past processing as the carries (Co0, Co1, . . . , Con) from one arithmetic and logic unit 5 as well. Note that the method of application of this second modification will be explained later (FIG. 13).

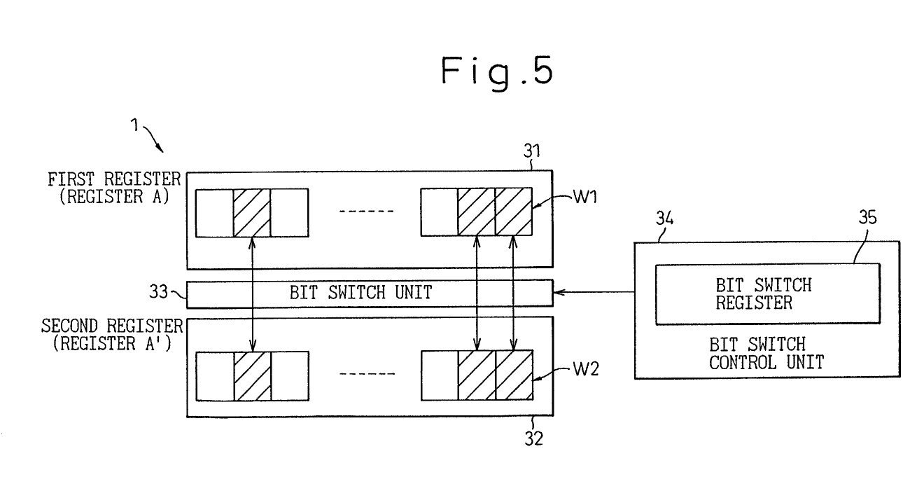

FIG. 5 is a view of a third principal portion of the processor according to the present invention.

As shown in the figure, the processor 1 is provided with a first register 31 for once storing the data to be processed in a first word W1 to be input to each arithmetic and logic unit 5 and a second register 32 for once storing the data to be processed in a second word W2 to be input to each arithmetic and logic unit 5.

The characteristic feature of the third principal portion resides in a bit switch unit 33. This bit switch unit 33 simultaneously switches bits among multiple bits with each other while aligning bit locations for the data stored in the first and second registers 31 and 32. Note that, in FIG. 5, an example of the data bit to be switched is indicated by hatching.

Preferably, the bit switch unit 33 cooperates with an illustrated bit switch control unit 34. Namely, this bit switch control unit 34 designates the location of the bit to be switched by the bit switch unit 33.

More concretely, this bit switch control unit 34 has a bit switch register 35 for storing the logic 1 or 0 for designating whether or not each bit in the first and second words W1 and W2 is at the location of a bit to be switched in correspondence with each bit.

Note that the bit switch is indispensable in for example the interleaving and that the storage of the logic 1 or 0 to the bit switch register 34 is externally set preceding the execution of the processing by the arithmetic and logic unit 5.

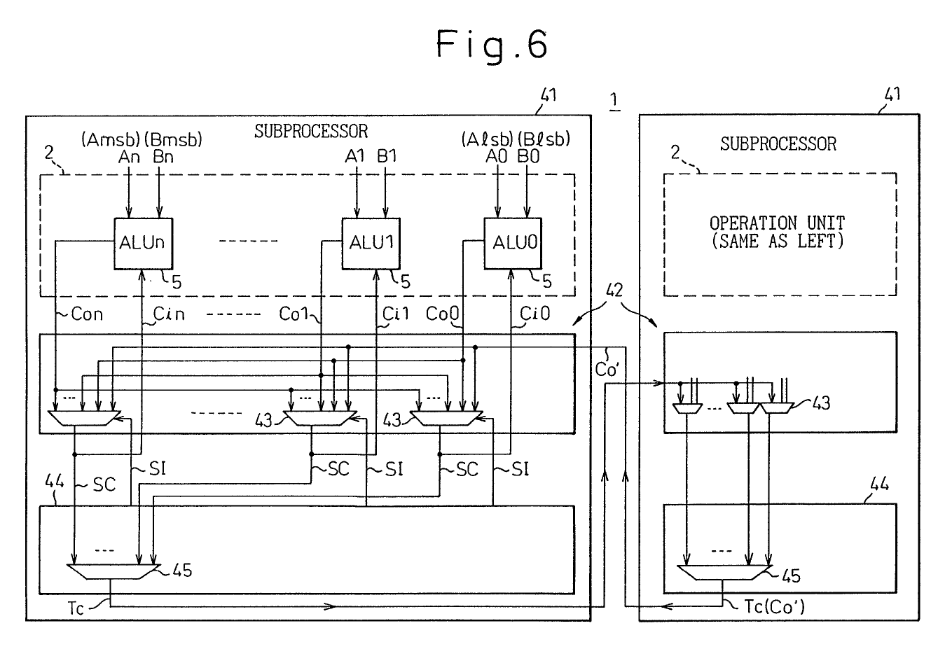

FIG. 6 is a view of a fourth principal portion of the processor according to the present invention.

The processor 1 shown in the figure is a processor comprised by connecting in parallel a plurality of (two in the figure) subprocessors 41 including a plurality of arithmetic and logic units 5 having configurations identical to each other and processing the data for every bit in one word unit. These subprocessors 41 are connected to each other via a carry I/O interface unit 42.

This carry I/O interface unit 42 becomes effective when the length of the data to be processed exceeds the bit length of one word (W), propagates the carry produced from the arithmetic and logic unit 5 in one of two adjoining subprocessors 41 to the arithmetic and logic unit 5 in the other subprocessor 41 and, at the same time, propagates the carry produced from the arithmetic and logic unit 5 in the other subprocessor 41 to the arithmetic and logic unit 5 in one subprocessor 41.

The carry I/O interface unit 42 preferably has a carry selector 43. This carry selector 43 receives as input the carry (Co0, Co1, . . . ) produced from each arithmetic and logic unit 5 and the carry Co′ produced from any arithmetic and logic unit 5 in the adjoining subprocessor 41 (right in the figure) in correspondence with each bit, selects one carry determined in advance, and propagates this to the arithmetic and logic unit 5 corresponding to each bit and, at the same time, transfers the selected carry to the adjoining subprocessor 41 (right in the figure) as well.

The carry I/O interface unit 42 is further provided with a transfer carry control unit 44. This transfer carry control unit 44 has transfer carry selectors 45 each receiving as input a selected carry SC selected by the carry selector 43 and selecting a transfer carry TC to be transferred to the adjoining subprocessor 41 (right in the figure) in correspondence with each bit and, at the same time, gives a select indication SI determined in advance with respect to each carry selector 43.

Above, a partial explanation was given of the first to fourth principal portions of the processor 1 according to the present invention. Therefore, an explanation will be given of the overall configuration of the processor 1 next. Note that the above first to fourth principal portions may be used alone or in any combination. Further, it is also possible to use all of these principal portions. In this case, a variety of variable length data naturally can be handled.

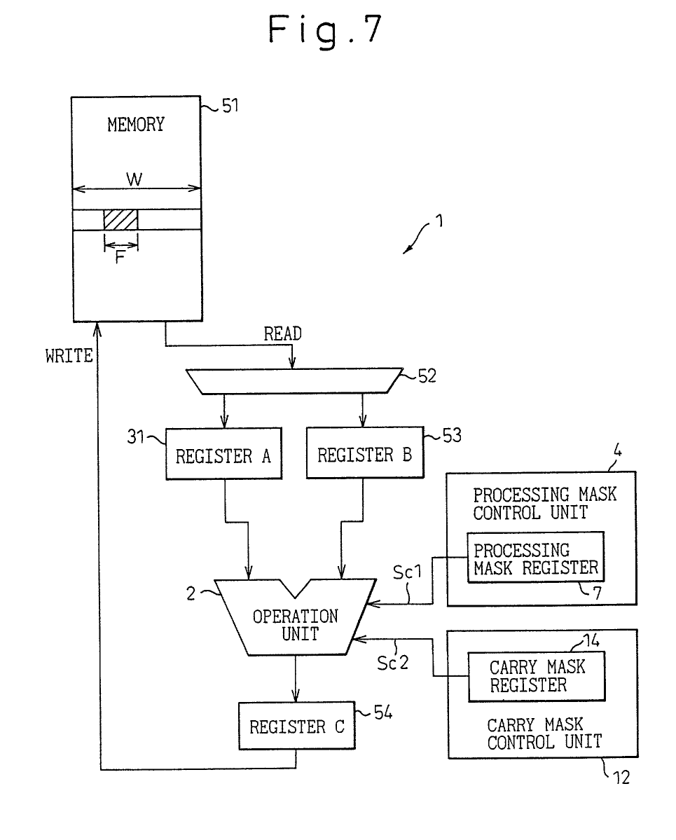

FIG. 7 is a view of a first example of the overall configuration of a processor according to the present invention.

The example of the overall configuration of the present figure shows a processor 1 employing both of the first principal portion (FIG. 1) and the second principal portion (FIG. 2, FIG. 3, and FIG. 4) described above (components 4, 7, 12, and 14 in the present figure).

In FIG. 7, one words worth (w in the figure) of data containing an effective field (F in the figure) to be processed is read from a memory 51 and stored in a register A (indicated by reference numeral 31). Below, an explanation will be given by dividing it into the case where the processing content is a logic operation (1) and the case where it is an arithmetic operation (2).

(1) Case where Processing Content is Logic Operation

Bits not to be processed are set in the processing mask register 7 of the processing mask control unit 4. The processing mask control unit 4 generates a control signal Sc1 based on the set value and outputs this to the arithmetic and logic unit array 2. The arithmetic and logic unit array 2 processes the fields (F) with respect to each other required for the processing in the register A and a register B (indicated by reference numeral 53) read from the memory 51 via a selector 52 according to the control signal Sc1 from the processing mask control unit 4, then stores the result of the processing in a register C (indicated by reference numeral 54).

At this time, for the data not to be processed, the value read from the memory 51 is output as it is from the arithmetic and logic unit array 2. Thereafter, the data stored in the register C is written at an original address which was read first from the memory 51.

(2) Case where Processing Content is Arithmetic Operation

In the same way as the case of the logic operation, by setting the bits not to be processed in the processing mask register 7 of the processing mask control unit 4, the effective fields F of each of the register A and the register B are processed.

At this time, when performing an arithmetic operation on data located at any position in the word (W) and having a variable bit length, a control facility enabling on/off setting of whether to propagate the carry (Co0, Co1, . . . ) produced as the result of the processing to any bit, that is, the configuration of FIG. 2, becomes effective.

Namely, by setting bits to which the carry is not to be propagated in the carry mask register 14 of the carry mask control unit 12, the carry mask control unit 12 generates a control signal Sc2 based on the set value in the register 14 and outputs this to the arithmetic and logic unit array 2.

The arithmetic and logic unit array 2 performs arithmetic operations on effective fields (F) in the data stored in the register A and the register B with respect to each other according to the control signals Sc1 and Sc2 input from the processing mask control unit 4 and the carry mask control unit 12.

Thereafter, in the same way as the case of the above logic operation, the result of processing from the arithmetic and logic unit array 2 and the data not to be processed are transferred to the register C. Further, a write operation is carried out with respect to the original address read first from the memory 51.

By the above (1) and (2), it becomes possible to perform an arithmetic and/or logic operation with respect to the data stored at any position in a word and having any length without aligning the boundaries of data as in a conventional processor, without shifting the data which was necessary at the time of storage of the data, without the masking of bits which were unnecessary at the time of processing, etc.

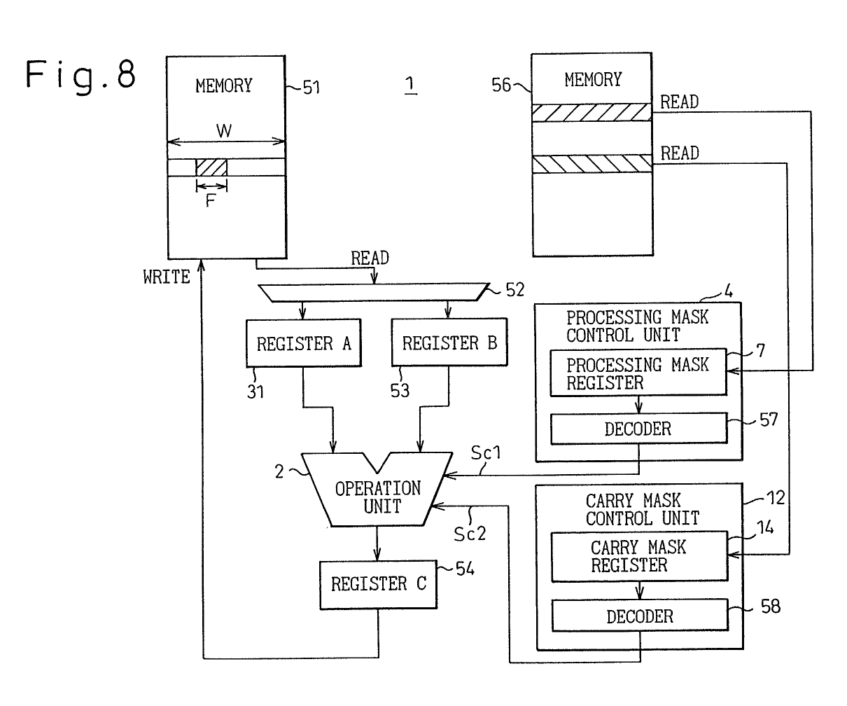

FIG. 8 is a view further concretely showing the configuration of FIG. 7 and further concretely shows particularly the processing mask control unit 4 and the carry mask control unit 12.

The components newly shown in the figure are the control memory 56 and decoders 57 and 58.

While the memory 51 stores the inherent data to be processed, the control memory 56 stores bit designation data (set values) to be given to the processing mask register 7 and the carry mask register 14.

The decoders 57 and 58 decode the bit designation data given to the registers 7 and 14 and produce the control signals Sc1 and Sc2.

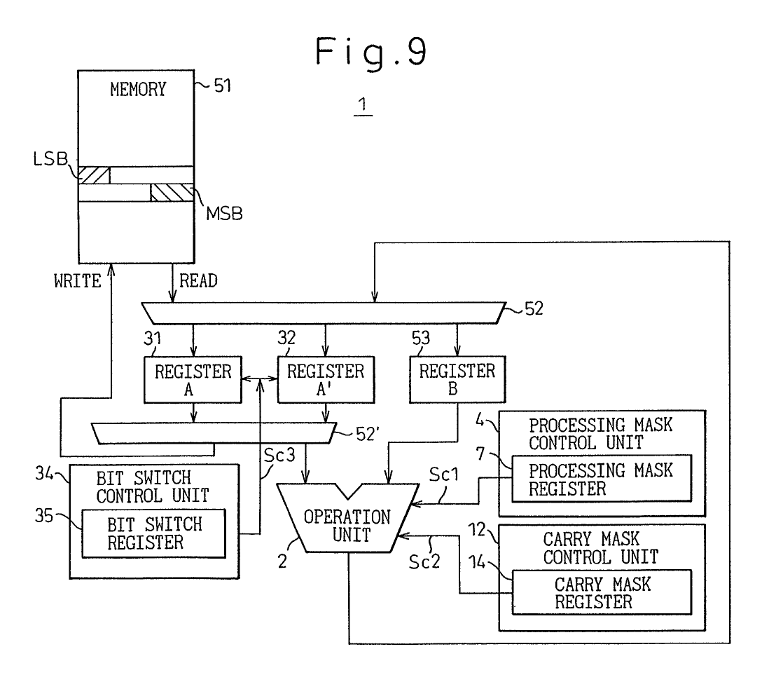

FIG. 9 is a view of a second example of the overall configuration of the processor according to the present invention.

The example of the overall configuration of the figure shows the processor 1 employing the first principal portion (FIG. 1), second principal portion (FIG. 2, FIG. 3, FIG. 4), and third principal portion (FIG. 5). Accordingly, the configuration of the figure corresponds to the configuration of FIG. 8 plus the bit switch control unit 34. Also, for this reason, the second register (register A′) 32 is further added to the configuration of FIG. 8. This register A′ is shown in FIG. 5.

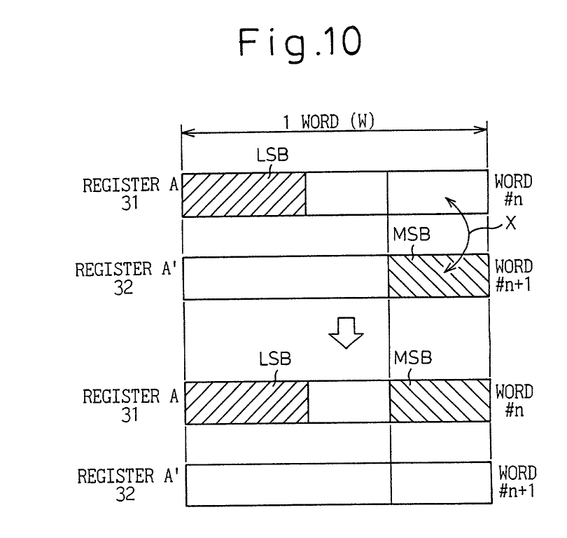

For understanding the bit switch control unit 34, first FIG. 10 will be referred to.

FIG. 10 is a first part of a view of the data structure used for the explanation of the bit switch control unit 34.

First, in a first stage, one word containing the least significant bit (LSB) is read from the memory 51 of FIG. 9 and stored as a word #n in the register A of FIG. 10.

Also, one word containing the most significant bit (MSB) is read from the memory 51 of FIG. 9 and stored as a word #n+1 in the register A′ of FIG. 10.

Next, in a second stage, the bit switch control unit 34 is operated and the bits are switched as illustrated by a two-directional arrow X of FIG. 10. Here, data having a data format shown in the lower portion of FIG. 10 is obtained. By this, exactly one word's worth of data is obtained, and a data format which can be processed by the arithmetic and logic unit array 2 is obtained. Data spanning two words' worth of the region shown in the memory 51 of FIG. 9 cannot be accepted at the arithmetic and logic unit array 2. Note that, as data having such a data structure, there is for example a VPI/VCI written in the header portion of each cell of the ATM mentioned above.

Returning to FIG. 9 again here, an explanation will be given of the operation of the processor 1 of the figure by referring to the above FIG. 10.

First, from among the data to be processed, one word's worth of the data (word #n) containing the LSB is read from the memory 51 of FIG. 9 and stored in the register A via the selector 52.

Next, one word's worth of the data (word #n+1) containing the MSB is read from the memory 51 and stored in the register A′. Here, the bit switch register 35 in the bit switch control unit 34 of FIG. 9 acts to switch any bit between the register A and the register A′. Namely, when bits to be switched are set in the bit switch register 35 of the switch control unit 34, the bit switch control unit 34 produces a control signal Sc3 based on the set value to the bit switch register 35 and switches the contents of the corresponding bits of the register A and the register A′ according to the set value.

By this, data to be processed stored spanning two words' worth of the region in the memory 51 will be stored in one word's worth of the register A. For a logic operation, in the same way as the case of FIG. 7, processing by the arithmetic and logic unit array 2 becomes possible.

In this way, by providing the bit switch control unit 34, it becomes possible to switch bits at a high speed—an operation which was difficult for conventional processors.

On the other hand, however, when the processing is an arithmetic operation, the carry produced as a result of the processing on the LSB side must be reflected at the MSB side. Therefore, the carry distribution unit 21 and carry distribution setting unit 22 shown in FIG. 3 are provided for enabling any bit of the output carry to input to any other bit.

Due to this, it becomes possible to process the data by setting any position of the data contained in the effective field as the MSB. In the final analysis, data stored spanning two words' worth of the region in the memory 51 can be processed in the same way as the case of FIG. 7.

After the above processing, the result of the processing is stored in the register A. Thereafter, the bit contents of the register A and the register A′ are switched according to the set values set in the bit switch register 35, and the data stored in the register A and the register A′ are written at the original address in the memory 51.

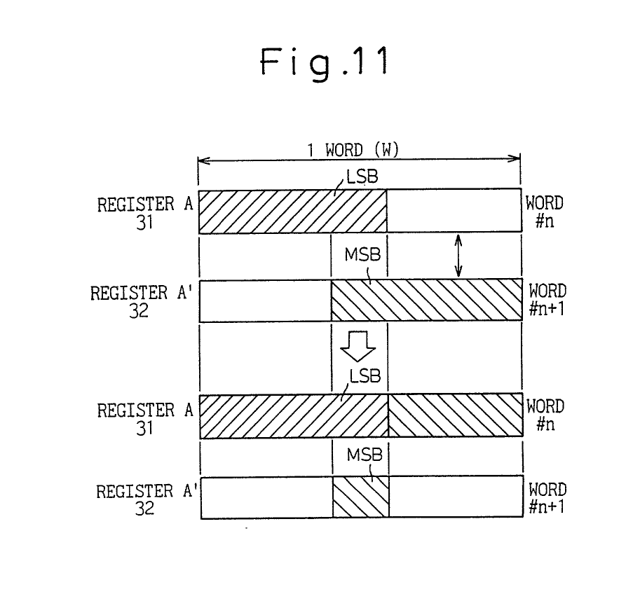

FIG. 11 is a second part of a view of the data structure used for the explanation of the bit switch control unit 34. In the case of this data structure, the processing becomes slightly complex, so an explanation will be given by referring to the following figures.

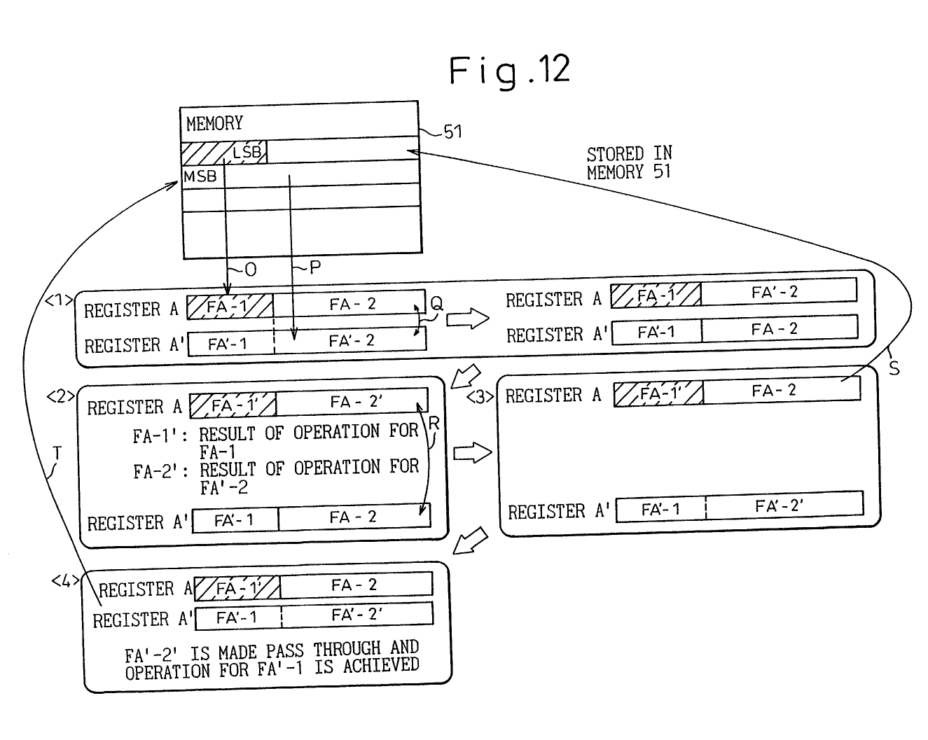

FIG. 12 is a view of the flow of processing when processing the data structure shown in FIG. 11. FIG. 13 is a view of the arithmetic and logic unit array partially employed in the flow of processing shown in FIG. 12. This arithmetic and logic unit array is based on the configuration of FIG. 4 mentioned above.

Referring to FIG. 11 first, the figure shows that there is an overlap of bits when switching bits between the register A and the register A′ (31 and 32 of FIG. 9). In the example of the data structure shown in FIG. 10 mentioned above, there is no such overlap of the bits, but in FIG. 11, there is an overlap at center portions of the registers A and A′ of the two upper parts of the figure.

When there is such an overlap, the flow of processing represented in FIG. 12 is executed by the processor 1 shown in FIG. 9.

After the data on the LSB side is loaded in the register A (arrow O), and the data on the MSB side is loaded in the register A′ (arrow P), the bits are switched (two-headed arrow Q) between the illustrated regions of FA-2 and FA′-2 by the bit switch control unit 34 (<1> of FIG. 12). Note that FA is an abbreviation of Field A.

Thereafter, the arithmetic and logic unit array 2 of FIG. 9 (ALU0, ALU1, . . . of FIG. 13) performs the processing using the data of the register A and the register B and stores the results of the processing in the register A (<2> of FIG. 12). At this time, the carries (Co0, Co1, . . . ) produced by the processing are held in the memory device 25 of FIG. 13.

Next, the bits are switched between the processed contents of FA-2′ and FA-2 (two-headed arrow R of FIG. 12).

Next, the content of the register A is written at the original address of the memory 51 (arrow S) (<3> of FIG. 12).

Further, next, the data of the register A′ and the register B and the carry bit held in the memory device 25 of FIG. 13 are input and the region corresponding to FA′-1 is processed. After this processing, the result of the processing is transferred to the register A′ (<4> of FIG. 12) and the content thereof is written into the memory 51 (arrow T).

After this, by repeating the processings of the above <1> to <4>, even when the data to be processed is stored over two or more words' worth of the region of the memory 51, the processing by the processor 1 is possible.

The configuration of FIG. 9 explained in detail above will be further supplemented below.

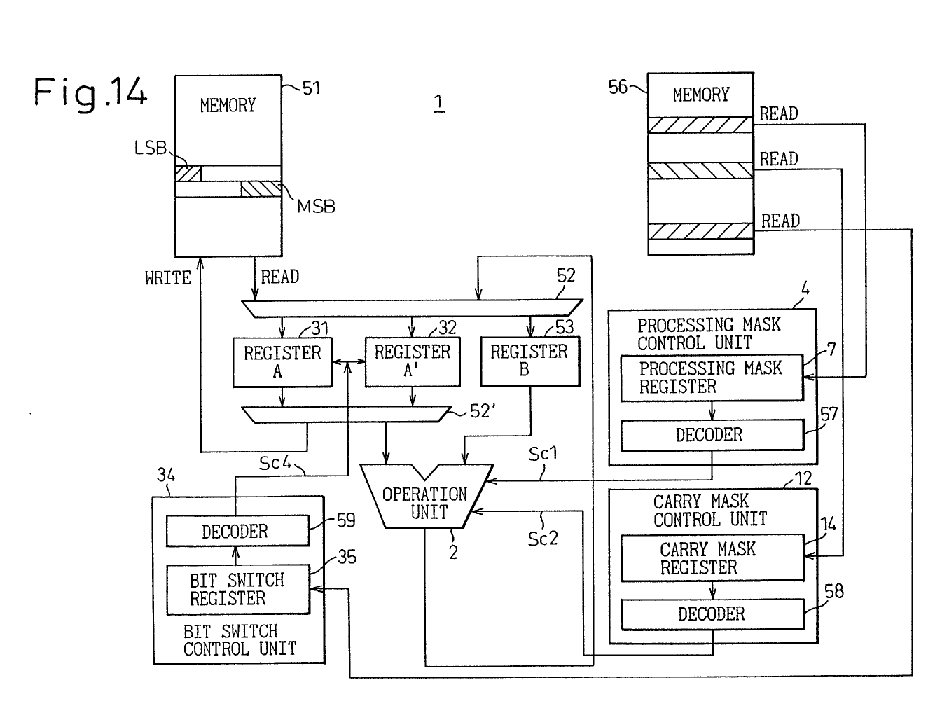

FIG. 14 is a view further concretely showing the configuration of FIG. 9. It concretely shows particularly the processing mask control unit 4 and the carry mask control unit 12 in the same way as FIG. 8 (concrete example of FIG. 7) and further concretely shows the bit switch control unit 34.

The concrete example of FIG. 14 corresponds to the concrete example shown in FIG. 8 plus the bit switch control unit 34. Namely, a decoder 59 in the control unit 34 is shown. The function of this decoder 59 is similar to the function of the decoders 57 and 58 explained in FIG. 8. A control signal Sc4 in accordance with the externally set value in the bit switch register 35 is produced by the decoder 59. This control signal Sc4 instructs bit switching as shown by the two-headed arrows Q and R in <1> and <2> of FIG. 12.

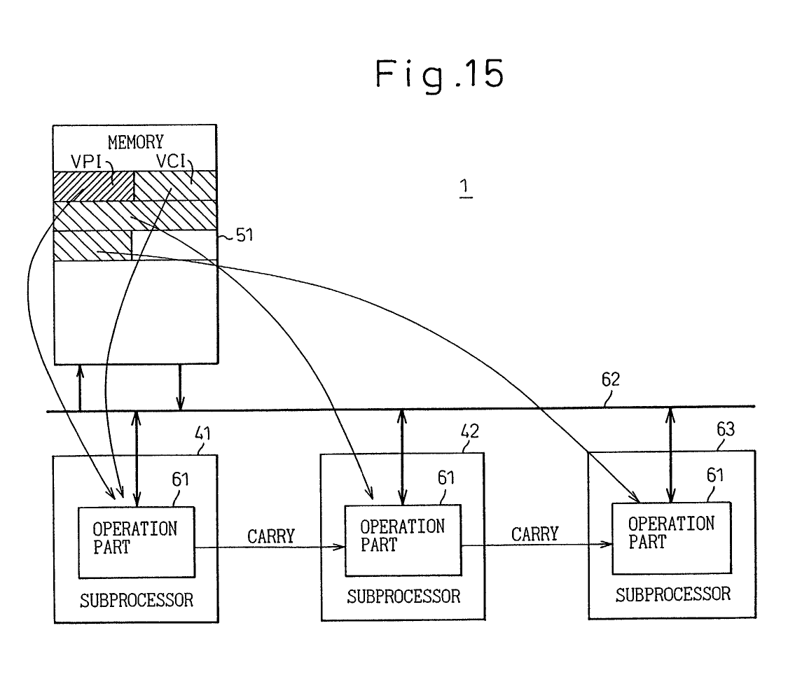

FIG. 15 is a view of a third example of the overall configuration of a processor according to the present invention.

The example of the overall configuration of the figure particularly shows the processor 1 employing the fourth principal portion shown in FIG. 6 mentioned above. Note, FIG. 15 shows an example where another subprocessor 63 is added. These subprocessors 41, 42, and 63 are connected to the memory 51 via a common bus 62.

The arithmetic and logic unit array 61 provided in each of the subprocessors 41, 42, and 63 is shown with the arithmetic and logic unit array 2 and the carry I/O interface unit 42 shown in FIG. 6 combined.

In FIG. 15, as an example of the data to be processed stored in the memory 51, the values of the header portion of the cell used for the ATM communication, particularly the VPI value (region of left downward hatching) and the VCI value (region of right downward hatching) are shown.

The three subprocessors 41, 42, and 63 divide tasks among them and perform arithmetic operations on VCI values spanning three words' worth of the region in the memory 51. The produced carries are transferred to the adjoining subprocessors.

The processor 1 having the multiprocessor configuration comprised of the three subprocessors (41, 42, and 63) shown in FIG. 15 can achieve further higher functions by the present invention. This will be explained in detail below.

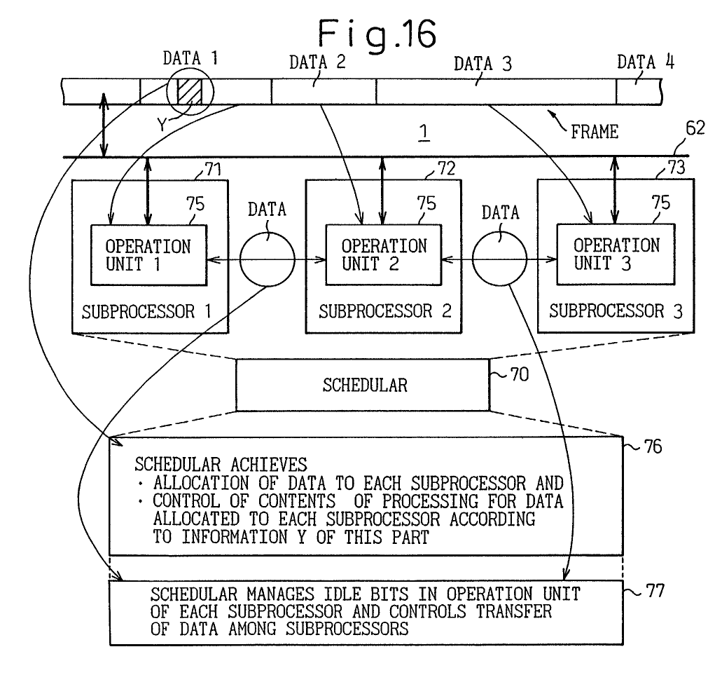

FIG. 16 is a view of a processor 1 having a multiprocessor configuration according to the present invention.

Namely, the processor 1 of the figure is a processor comprised by connecting in parallel a plurality of subprocessors (71, 72, and 73) including a plurality of arithmetic and logic units 5 having identical configurations and performing data operations for every bit in one word unit. This processor 1 operates under a predetermined scheduler 70.

Any of the subprocessors 71, 72, and 73 act when the length of the data to be processed exceeds the bit length of one word (W). The scheduler 70 allocates the data to the plurality of subprocessors for distributed processing and controls the processing at each subprocessor to which the data is allocated.

Note that the arithmetic and logic units 75 in the subprocessors have identical configurations and are formed by including at least the arithmetic and logic units 5. Also, the scheduler 70 performs the processing in a block 76 according to control information Y in the frame.

The scheduler 70 also performs processing in a block 77. The transfer of data among subprocessors includes the transfer of the carry mentioned above. Further, the scheduler 70 also manages idle bits (IDLE) of the arithmetic and logic unit 75 as shown in this block 77.

Thus, the scheduler 70 makes it possible for other subprocessors to use an idle arithmetic and logic unit 5 when one or more arithmetic and logic units 5 in one subprocessor become idle. Thus, a processor for processing variable length data having a good operating efficiency can be realized.

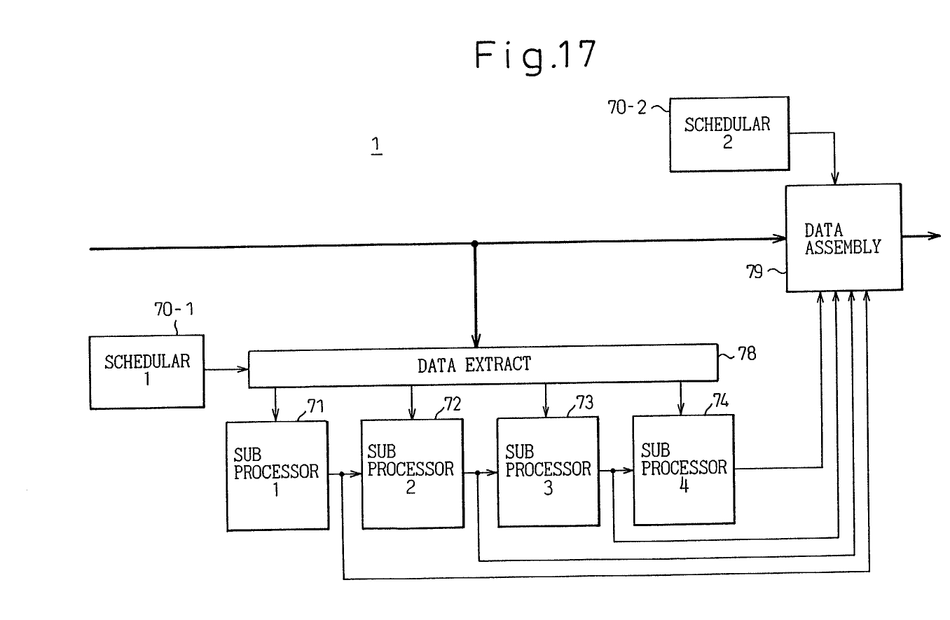

FIG. 17 is a view of an example of the overall configuration of FIG. 16. Note that a further subprocessor (74) is added.

The schedulers 70 (70-1 and 70-2) supply the data via a data extracting means 78 to the subprocessors (71 to 74) and integrate the results of the distributed processing from the subprocessors (71 to 74) via a data assembly means 79. The figure shows an example where the schedulers 70-1 and 70-2 individually act with respect to the means 78 and 79.

Note that pipeline processing or parallel processing can be set as the distributed processing.

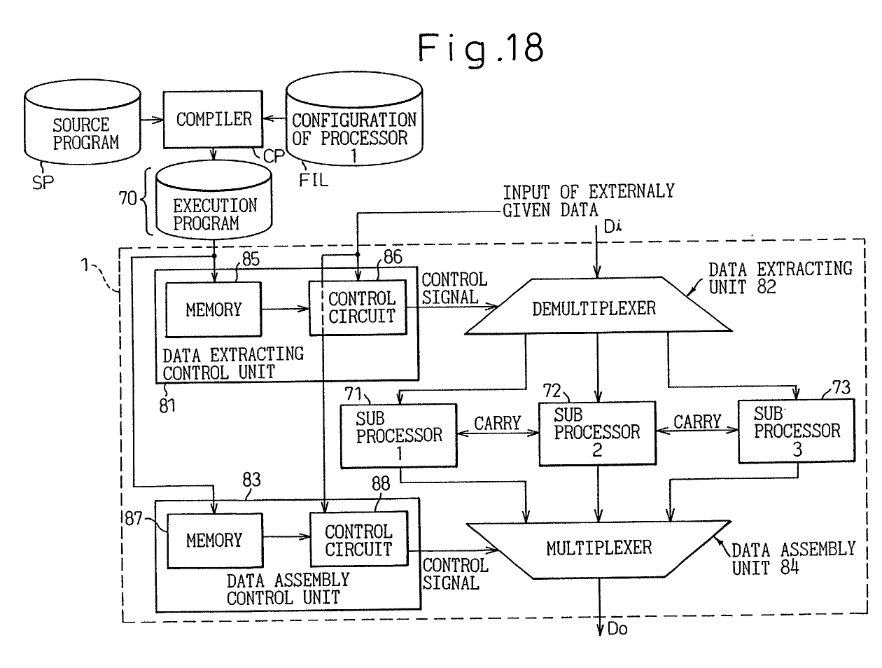

FIG. 18 is a view of a detailed example of the overall configurations shown in FIG. 16 and FIG. 17.

The data extracting means 78 is shown as a data extracting control unit 81 and a data extracting unit 82 in FIG. 18. Also, the data assembly means 79 is shown as a data assembly control unit 83 and a data assembly unit 84 in FIG. 18.

Note that, for simplification, three subprocessors 71 to 73 are shown in FIG. 18.

The data extracting unit 82 is comprised of a demultiplexer and allocates input data Di to the subprocessors (71 to 73) by the control signal output from the data extracting control unit 81. This data extracting control unit 81 is comprised of a memory 85 and a control circuit 86 controlled by the execution program stored in the memory 85. This execution program corresponds to the above scheduler (compiler) 70 (70-1).

The data assembly unit 84 is comprised of a multiplexer, couples the data output from the subprocessors (71 to 73) by the control signal output from the data assembly control unit 83, and outputs the same as an output data DO to the outside. This data assembly control unit 83 is comprised of a memory 87 and a control circuit 88 controlled by the execution program stored in the memory 87. This execution program corresponds to the scheduler (compiler) 70 (70-2).

The execution program (70) is obtained by the compiler CP compiling a source program SP describing the processing content. The compiler CP generates an execution program (70) conforming with the configuration of the system (processor 1) covered in a file FIL.

By employing the multiprocessor configuration as described above, the arithmetic and logic unit array 2 mounted in each subprocessor can be operated as an arithmetic and logic unit array having a long bit length (functions are the same in all arithmetic and logic unit arrays).

Finally, an explanation will be given of the instructions for operating the processor 1 according to the present invention, particularly the data structure thereof.

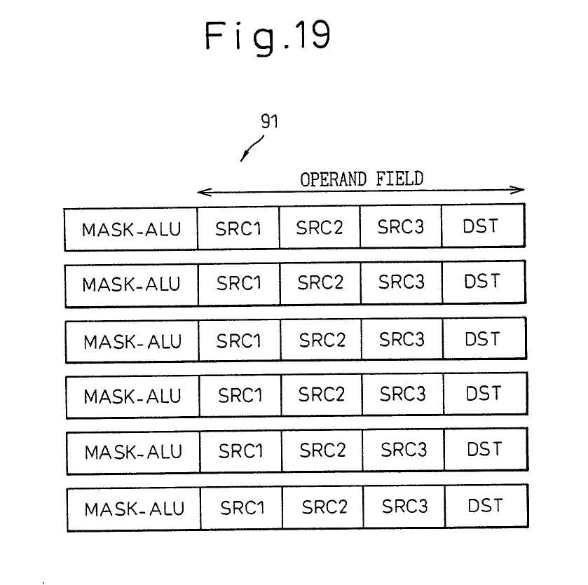

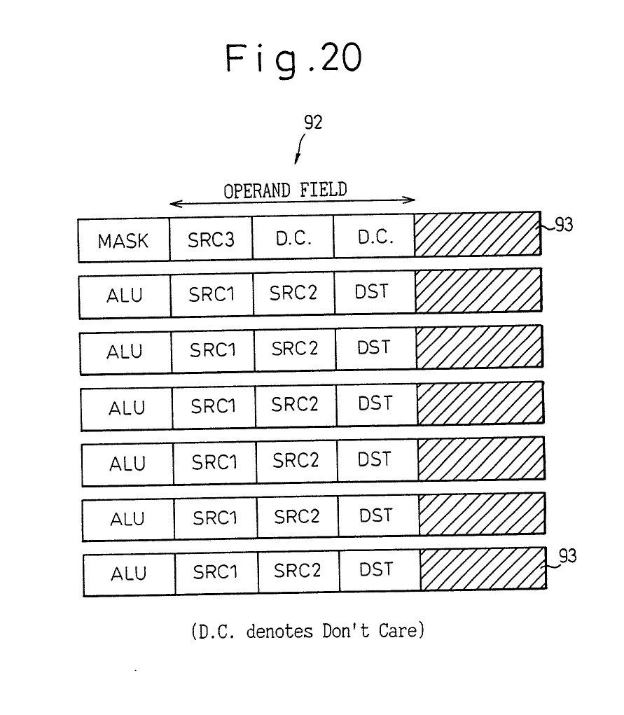

FIG. 19 is a view of a typical instruction structure for operating the processor according to the present invention, and FIG. 20 is a view of the instruction structure based on the present invention for operating the processor according to the present invention.

Referring to FIG. 19 first, in typical instructions 91, MASK-ALU represents a masked operation, SRC1 and SRC2 designate the already mentioned registers with the data input thereto, SRC3 represents the above mask data, and DST designates a register from which the processed data is output.

Namely, an operand portion of such instructions 91 is comprised of

[1] two fields (SRC1 and SRC2) for designating the data to be input,

[2] one field (DST) for designating a destination of output, and

[3] one field (SRC3) for designating a location where a mask pattern is stored.

On the other hand, referring to FIG. 20, among the instructions 92 based on the present invention, the mask instruction MASK and the data SRC3 for designating the mask data appear only one time at the start of the instructions. Thereafter, only ALU instructions (SRC1+SRC2+DST) are repeated.

In a communication oriented application to which the processor for processing variable length data of the present invention is applied, regular processing is often repeated. The mask pattern is also constant in many cases. In such an application, there is a high possibility of a field (SRC3) for designating the mask pattern becoming redundant in the configuration of the operand portion shown in FIG. 19.

Therefore, a dedicated register (processing mask register 7) to which the mask pattern is input is provided and the system is configured to set values in this processing mask register 7 and perform processing independently (FIG. 20). The word length of the instruction was made less than the case where the configuration of FIG. 19 is employed. By this, it becomes possible to reduce the required capacity of the memory storing the instructions. Further, it also becomes possible to accommodate another field in the field 93 which becomes idle thereby.

Thus, in the processor 1 operating by the instructions of FIG. 20, that is, a processor including a plurality of arithmetic and logic units 5 each executing processing on data according to predetermined instructions for every bit in one word unit and, at the same time, with preprocessing executed therein preceding the processing, the following instructions are effective.

These instructions are divided into first instructions (MASK) for storing parameters (set values) required for the above preprocessing in a predetermined parameter register (for example register 7) and second instructions (ALU) comprised of a set of the same operation instructions for repeatedly executing the above processing, each operation instruction comprised of two fields (SRC1, SRC2) for individually designating two input registers (register A, register B) for storing two sets of data to be processed.

Each operation instruction in the second instructions (ALU) uses the parameters (set values) in the parameter register (register 7) described above at the time of preprocessing.

The above explanation was given with reference to a processing mask register, but by separating the instructions into instructions for setting values (corresponding to MASK) and operation instructions (ALU) in the same way for the carry mask register 14 and the bit switch register 35, the memory for the instructions can be efficiently used.

Further, in the case of the processor 1 of the multiprocessor configuration shown in FIG. 15, FIG. 17, etc., if the subprocessors commonly use the parameter register, the memory for instructions can be further efficiently used.

Namely, when the processor 1 is a processor of a multiprocessor configuration comprised of subprocessors (71 to 74) including a plurality of arithmetic and logic units 5 for processing the data for every bit in one word unit according to predetermined instructions and executing preprocessing preceding this processing, the subprocessors can share the parameter register to execute the preprocessing in the first instructions.

As explained above, according to the present invention, a processor can be realized which

1) eliminates the need for the step of preprocessing the data by a combination of shift instructions for alignment of boundaries of the data and mask instructions for masking of bits, which has been required according to the conventional procedure,

2) eliminates the need for the preprocessing instructions for the preprocessing step, and

3) enabling the preprocessing step without adding dedicated hardware.

Accordingly, the processing of variable length data which sometimes exceeds one word can be executed in real time at a high speed with a high efficiency while reducing the required capacity of the memory as much as possible. Further, the interleaving and the deinterleaving can be executed by extremely simple processing.

While the invention has been described by reference to specific embodiments chosen for purposes of illustration, it should be apparent that numerous modifications could be made thereto by those skilled in the art without departing from the basic concept and scope of the invention.

What is claimed is:

1. A processor for processing variable length data including a plurality of arithmetic and logic units for processing data for every bit in a word unit, provided with:
a processing mask control unit for designating bits for dividing the data in each word to data to be processed and other data not to be processed and
an output select unit for selectively validating the function of processing by an arithmetic and logic unit in correspondence with the related bits for the above data to be processed and fetching results of the processing according to the above designation of bits by the processing mask control unit and the function of passing the data not to be processed through an arithmetic and logic unit in correspondence with the related bits.

2. A processor for processing variable length data as set forth in claim 1, wherein said processing mask control unit has a processing mask register for storing a logic 1 or 0 for designating whether each bit in said each word is a bit to be processed or a bit not to be processed in correspondence with each bit.

3. A processor for processing variable length data as set forth in claim 2, wherein said output select unit is comprised of output selectors receiving as input both the result of processing from said arithmetic and logic unit and said data not to be processed passed through the arithmetic and logic unit, in correspondence with each bit, selecting one of the above result and the above data, and outputting the selected one and where each output selector performs the selection according to said logic 1 or 0 from said processing mask register.

4. A processor for processing variable length data including a plurality of arithmetic and logic units for processing data for every bit in a word unit, provided with:
a carry mask control unit for designating carry propagation for setting whether or not the carry produced from one arithmetic and logic unit is to be propagated to the other arithmetic and logic unit between adjoining arithmetic and logic units in correspondence with each bit and
a carry select unit for selectively validating a function of propagating a carry from one arithmetic and logic unit to the other arithmetic and logic unit according to said carry propagation designation by said carry mask control unit and a function of giving a fixed logic determined in advance as the carry to the other arithmetic and logic unit.

5. A processor for processing variable length data as set forth in claim 4, wherein said carry mask control unit has a carry mask register for storing a logic 1 or 0 for designating whether to propagate said carry or to give said fixed logic in correspondence with each bit.

6. A processor for processing variable length data as set forth in claim 4, wherein said carry select unit performs the selection by adding a function of selecting a carry from a memory device for storing carries produced by past processing as said carries from said one arithmetic and logic unit as well.

7. A processor for processing variable length data as set forth in claim 5, wherein said carry select unit is comprised of carry selectors receiving as input both of said carry from said arithmetic and logic unit and said fixed logic, in correspondence with each bit, and selecting one of the above carry and the above fixed logic and outputting the selected one and where each carry selector performs the selection according to said logic 1 or 0 from said carry mask register.

8. A processor for processing variable length data including a plurality of arithmetic and logic units for processing data for every bit in a word unit, provided with:
a carry distribution unit for propagating a carry produced from one arithmetic and logic unit to other arithmetic and logic unit between arithmetic and logic units.

9. A processor for processing variable length data as set forth in claim 8, wherein said carry distribution unit is comprised of carry selectors receiving as input carries produced from said arithmetic and logic units in correspondence with each bit, selecting one carry determined in advance, and propagating the same to the arithmetic and logic units in correspondence with each bit.

10. A processor for processing variable length data as set forth in claim 9, further provided with a carry distribution setting unit for determining in advance from which arithmetic and logic unit the carry produced is to be selected for each said carry selector and designating the same.

11. A processor for processing variable length data including a plurality of arithmetic and logic units for processing data for every bit in a word unit, provided with
a first register for once storing data to be processed in a first word to be input to each arithmetic and logic unit,
a second register for once storing data to be processed in a second word to be input to each arithmetic and logic unit, and
a bit switch unit for simultaneously switching bits among multiple bits with each other while aligning bit locations for the data stored in the first and second registers.

12. A processor for processing variable length data comprised by connecting in parallel a plurality of subprocessors, each containing a plurality of arithmetic and logic units having identical configurations and processing data for every bit in a word unit, wherein each subprocessor is provided with:
a carry I/O interface unit which becomes effective when a length of said data to be processed exceeds the bit length of said one word, propagates the carry produced from an arithmetic and logic unit in one of two adjoining said subprocessors to an arithmetic and logic unit in the other subprocessor and propagates the carry produced from the arithmetic and logic unit in said other subprocessor to the arithmetic and logic unit in said one subprocessor.

13. A processor for processing variable length data as set forth in claim 12, wherein each carry I/O interface unit has a carry selector receiving as input the carry produced from each arithmetic and logic unit and the carry produced from any arithmetic and logic unit in adjoining subprocessors in correspondence with each bit, selecting one carry determined in advance and propagating this to the arithmetic and logic unit corresponding to each bit and transferring the selected carry to said adjoining subprocessor.

14. A processor for processing variable length data as set forth in claim 13, wherein each said carry I/O interface unit further has a transfer carry control unit having transfer carry selectors each receiving as input a selected carry selected by said carry selector and selecting a transfer carry to be transferred to said adjoining subprocessor in correspondence with each bit and giving a select indication determined in advance with respect to each said carry selector.

15. A processor for processing variable length data comprised by connecting in parallel a plurality of subprocessors, each containing a plurality of arithmetic and logic units having identical configurations and processing the data for every bit in a word unit, provided with:
a scheduler functioning when the length of said data to be processed exceeds the bit length of said one word, allocating data to said plurality of subprocessors for distributed processing, and controlling the processing at the subprocessors to which the data is allocated.

16. A processor for processing variable length data as set forth in claim 15, wherein said scheduler makes the other subprocessor use the related arithmetic and logic unit when one or more of said arithmetic and logic units in one subprocessor become idle.
